(19) United States
(12) Patent Application Publication
(10) Pub. No.: US 2007/0031795 A1
(43) Pub. Date: Feb. 8, 2007

(54) Method and materials for encouraging creative thinking, planning or decision making

(75) Inventors: Bart Victor, Nashville, TN (US); Johan Roos, Denes (CH); Robert K. Rasmussen, Longmeadow, MA (US)

Correspondence Address: PITNEY HARDIN LLP, 7 TIMES SQUARE, NEW YORK, NY, 10036-7311, US

(73) Assignee: EXECUTIVE DISCOVERY LTD.

(21) Appl. No.: 11/580,259

(22) Filed: Oct. 12, 2006

Related U.S. Application Data
(63) Continuation of application No. 09/772,810, filed on Jan. 30, 2001.

(51) Int. Cl. G09B 19/18

(52) U.S. Cl. 434/107

(57) ABSTRACT

A program, method and materials for enhancing creative thinking, communication, decision-making and strategic planning. The program, materials and method are based on the interplay between physical manipulation of symbolic objects and the effect of such manipulation on the ability to deal with actual objectives. For example, by physically manipulating building blocks, such as those having a stud configuration, (such as those sold under the LEGO® trademark), which are fastened together with studs from a top of one block fitting into receptacles on the bottom of another block, the thinking processes can be fostered and/or enhanced.

### BACKGROUND OF THE INVENTION

The invention relates to enhancing the thinking process of individuals and more particularly to a program, method and materials for encouraging creativity and enhanced communication, strategic planning and decision-making among employees of a company.

Conventional methods of enhancing thinking, imagination, creativity, communication, decision-making or planning can involve the use of motivational speakers, who provide positive and/or negative reinforcement of specified concepts in a generally passive setting. Occasionally, corporations have deemed it advisable to send their employees on retreats, where team work is fostered through physical activity and challenges, in the hopes that such team work will continue in the work place, after the physical activities are completed. These activities are generally unrelated to specific company related topics.

Conventional strategic planning sessions might involve one or more individuals brainstorming a series of objectives, which are whittled down into a smaller set of objectives. Then, teams of one or more individuals are often established for completing the objectives. Conventional tools for reaching these objectives include research materials, whether in printed or electronic form, information about past solutions used to address similar problems and the like.

Conventional methods of strategy-making are considered by many to be outdated or not fully satisfactory for achieving desired results, particularly in today's fast-moving global economy, where revolutionary changes in business methods and technologies occur more and more frequently. Accordingly, it is desirable to provide an improved program and method for enhancing creative thinking, communication, decision-making and/or strategic planning, which have not been available in the prior art.

### SUMMARY OF THE INVENTION

Generally speaking, in accordance with the invention, a program, method and materials for enhancing creative thinking, communication, decision-making and strategic planning are provided. The program, materials and method are based on the interplay between physical manipulation of symbolic physical objects, visualization and the effect of such manipulation and visualization on the development and enhancement of the ability to imaginatively, thoughtfully and creatively deal with actual situations and objectives. For example, by physically manipulating building blocks, (such as those having stud or knob configurations, which are fastened together such that the studs from the top of one block can fit into receptacles on the bottom of another block), in connection with discussions relating to objects built with the blocks, (which are symbolic of aspects of business) the thinking processes, creative processes and effectiveness of individuals can be fostered and/or enhanced.

Building objects that relate to topics for discussion enhances an individual's ability to psychologically become involved with the discussion topics. The creations become props for fostering and/or enhancing the discussion of selected topics and lead to more productive and creative communication. The invention also involves written materials and sets of building blocks that are associated with the written materials to guide the discussion and building sessions. Programs conducted in accordance with the invention can use the tools of building physical metaphors, telling stories, telling stories involving physical metaphors, imagination, and the enhancement of imagination through constructing models of things imagined, and then the modification of such models to create things previously unimagined, to enhance a participant's ability to achieve goals of increased understanding and decision-making.

Accordingly, it is an object of the invention to provide an improved program, method and set of materials for enhancing creative thinking, decision-making and strategic planning.

Other objects and advantages of the invention will in part be obvious and will in part be apparent from the specification and drawings.

The invention accordingly comprises the several steps and the relation of one or more of such steps with respect to each of the others, and the materials embodying features of construction, combinations of elements and arrangements of parts, which are adapted to be used in conjunction with and to guide such steps, all as exemplified in the following detailed disclosure, and the scope of the invention will be indicated in the claims.

### BRIEF DESCRIPTION OF THE DRAWINGS

For a fuller understanding of the invention, reference is had to the following description, taken in connection with the accompanying drawings, in which:

FIG. 1A is a perspective view of an exemplary model in accordance with an embodiment of the invention;

FIGS. 1B-1E are perspective views of demonstrative instructions for building the model of FIG. 1A;

FIG. 2A is a perspective view of an exemplary model in accordance with an embodiment of the invention;

FIGS. 2B-2E are perspective views of demonstrative instructions for building the model of FIG. 2A;

FIG. 3 is a perspective view of an exemplary model in accordance with an embodiment of the invention; and

FIG. 4 is a perspective view of a plurality of exemplary physical metaphors, connected to each other in various ways, with flash point markers on selected connections, to symbolize the various aspects of a business, how those aspects, referred to as agents, interact and where change in those interactions can have significant effects on a business, in accordance with embodiments of the invention.

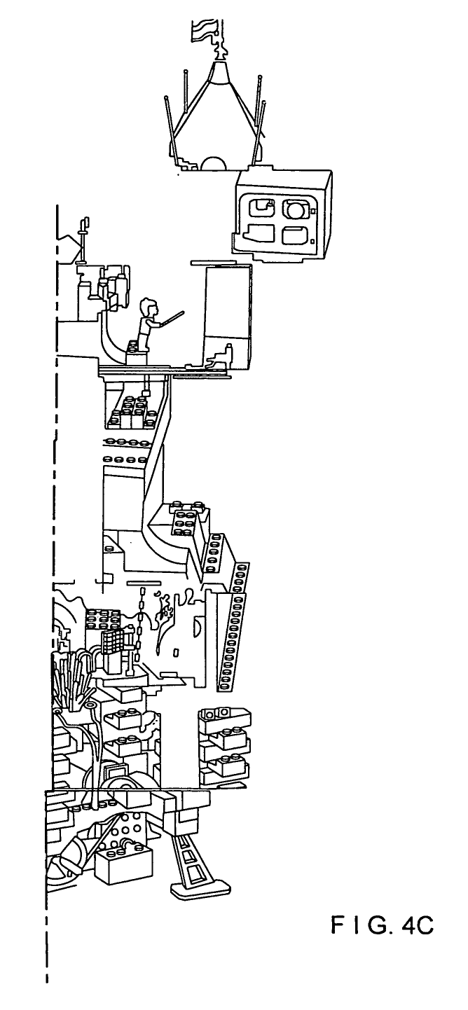

### DETAILED DESCRIPTION OF THE PREFERRED EMBODIMENTS

The invention involves the use of physical manipulation of objects such as building blocks, which relate to topics for discussion by individuals or groups, such as groups of stakeholders in a company (such as employees, customers, officers, directors, advisors, etc.). The invention also involves a program, which can include written materials and/or building materials, for guiding the activities of the program, where participants can first become comfortable building objects with building blocks, and then can become comfortable discussing with the group what they built. This can help foster a better understanding of a business situation, awaken suppressed creativity, increase understanding and foster openness of participants. Then, new models can be built that can have a closer relationship to specific topics, such as aspects of a business and the discussions can have a more pointed theme, such as how an aspect of a business affects the rest of the business or whether generalized guiding principles can be developed to address future challenges.

It is believed that to foster creativity, imagination, thinking and enhanced communication, it is necessary at times to make choices that do not have real-life effects and consequences. Play can be a context in which risks can be taken without real world consequences, in which the unimaginable can be imagined without fear and in which the unlooked for can be realized without hesitation. Thus, when creative and planning processes or other areas where creativity or deeper insight is needed are linked to play, the process becomes both more enjoyable and productive. Accordingly, the invention links play to the thinking process as a means to enhance the process.

It is also believed that the human mind learns and develops best and retains the most when it is actively involved in what it is trying to learn, as opposed to passively receiving the information. For example, one can better construct one's own internal mental maps when one builds physical models, which can be examined, shared and discussed. This can be more productive than merely discussing abstract ideas. Thus, the invention involves the creation of models as part of the creative process.

It is also believed that when a participant learns to do something with his/her hands, or when he/she manipulates something with his/her hands, an extremely complicated thought process emerges that can have more significant effects, compared to when concepts are discussed or thought of only in the abstract. Thinking and talking about concepts, such as how to understand and improve a business or how to plan for changes in the business landscape, have traditionally failed to involve the powerful thought processes which are initiated when one makes something with one's hands. Using one's hands to make something real leads to a much deeper and more personal learning experience. Thus, what is learned in the process of creating brick models, for example, sinks in much deeper than what one would learn in a traditional abstract strategy-making or discussion-making session. This is because such conventional sessions have largely ignored the interdependency of hand and brain function, the historic origin of that relationship or the impact of that history on the development and dynamics of brain function in modern humans.

Various concepts can be used in connection with employing constructed models to assist the thinking process. For example, if a participant in a program conducted in accordance with the invention wants to see more than they can imagine, the participant can build what they can imagine and then modify what they built into what they could not have imagined. Also, it is evident that when a participant's mind becomes stuck and the creativity process stalled, his/her mind can be released and the creative process restarted by getting the participant's hands actively involved in the creative process. Thus, permitting the participant to hold the problem in his/her hands and attempt to fix the problem with his/her hands can dramatically enhance the insight of the participant beyond what can be accomplished without getting his/her hands involved.

Building models as metaphors for problems, for example, can also enhance a group's working, creative and planning environment. Just as a participant can learn from what others say, the participant can learn from watching what others build. Also, making a model can assist the participant in presenting a concept to a group and enhance the understanding of the concept by the group members.

The making of models as metaphors is an important aspect of the invention. Metaphors can lead participants to think about realities in different ways, thereby unleashing the participant's imagination so that he/she can more fully describe the world as he/she sees it, make an entirely new description of an object, concept or person, and challenge old assumptions and beliefs. These new descriptions can allow the participants to see new possibilities. The ability to find and express insightful similarities between two objects and concepts through the creation and use of metaphors is an important element of the idea generation process during programs conducted in accordance with the invention.

Employing word metaphors in the context of business creativity and planning is not new. For example, many words that are used in business have been borrowed from the field of life sciences. Descriptions of niche markets, product life cycles or business landscapes or comparing companies to highly involved hawks or less evolved kiwis can help humans understand the nature of companies or products and make decisions based on an understanding enhanced by the use of word metaphors. Similarly, by using physical models as metaphors, program participants can gain an increased understanding of a business, project or product. It has been found that the use of models which can be manipulated, changed, constructed and reconstructed can provide participants with far greater understanding and appreciation, leading to enhanced creativity, decision-making or planning, compared to the use of mere words or static models, alone.

By way of non-limiting example, it has been found that the use of connectable and detachable blocks, such as toy bricks in which the knobs (or studs) of one block fit into receptacles of another block, which itself has knobs and/or receptacles for connecting to still another block, provides a highly effective material for building objects which serve as dynamic metaphors in accordance with preferred embodiments of the invention. Preferred blocks of this type are sold under the LEGO® trademark. Such blocks are particularly advantageous, because they can be used to construct and reconstruct the metaphors, without being changed or damaged in the process. Such blocks can also lead to virtually endless creative possibilities. For example, there are approximately 100,000,000 different ways to combine six 8-stud bricks of the same color. There are also approximately 1,600 ways to combine three 8 stud bricks of the same color and 24 ways to combine two 8 stud bricks of the same color.

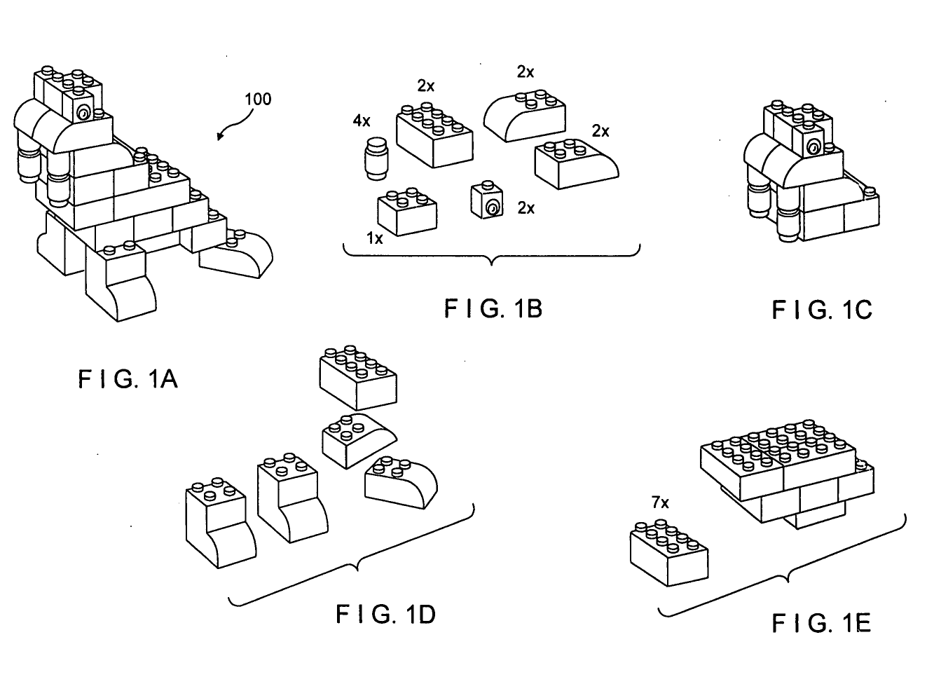

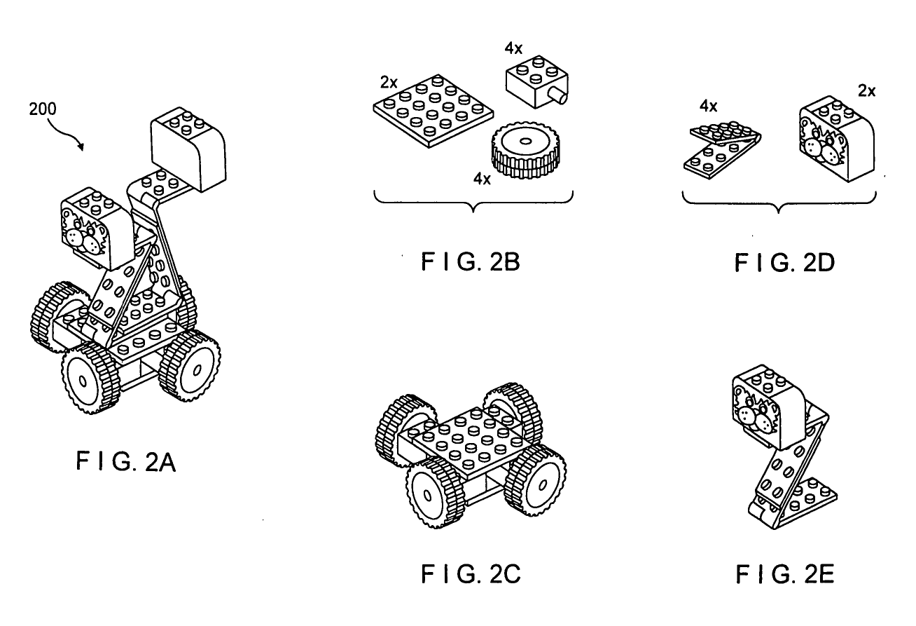

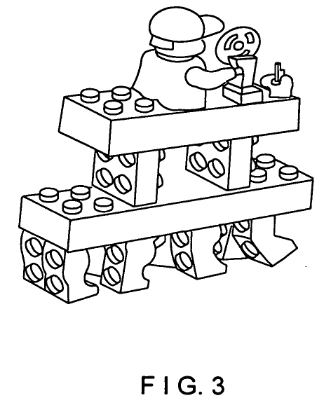

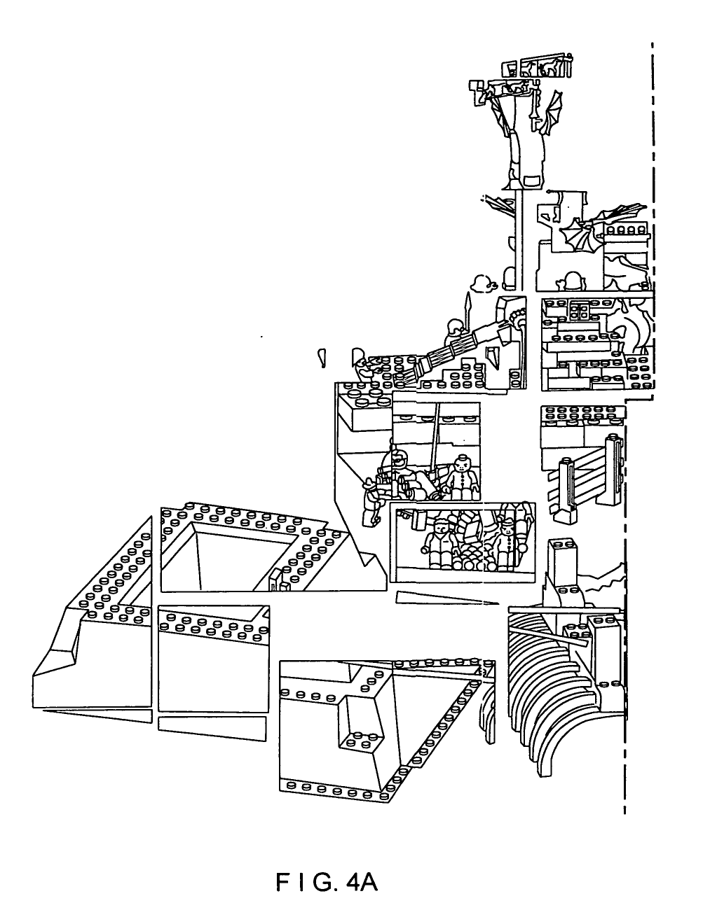

By way of further non-limiting example, the use of building blocks can be used to enhance the strategic thinking process. The first step in a program conducted in accordance with embodiments of the invention can be to become familiarized and comfortable with creating objects out of such blocks. Participants can look at pre-constructed models or pictures of models and then, following instructions, build the model selected. For example, a model 100 is shown generally in FIG. 1A. FIGS 1B-1E represent the demonstrative instructions for making model 100. The simple process of following the guidance provided by FIGS. 1B-1E, can be important for reawakening certain dormant creative processes. In one aspect of the invention, participants can be given the choice between following the instructions for making any of a set of models. Another non-limiting example are the instructions of FIGS. 2B-2E for making a model 200 of FIG. 2A.

The models created can then be used to initiate topics of conversation. For example, the participants can be asked, either by a trainer running a program or by following written, audio or video materials, to discuss whether they came across anyone they knew or recognized when viewing the models they were to select from.

As can be seen, model 100 depicts a walrus type creature. Model 200 depicts a lion type creature, with wheels that permit it to spin in circles. Other possible models to choose from can be snakes, chickens, toads, birds, sheep and so on. The participants in the program can also be asked to identify the types of animals that are metaphors for the people they work with and the types of animals they look for in their business. It is-believed that the physical manipulation in creating the models will serve to enhance the creativity and effectiveness in the associated discussions.

The participants in programs conducted in accordance with embodiments of the invention can also be asked to discuss what various other preconstructed models, depicted in two or three dimensions, bring to mind. For example, participants might view certain models as a speed snail [?], a transparent model as representing a company bonus, a singing bird-like model as representing a company goal and a raised platform type structure as a tax shelter. The key is for the models to initiate communication of thought. The participants can use these models to help convey their thoughts.

Metaphors can help establish common themes and ideas upon which a group can base their discussion of issues. As such, they can form part of a common language used by several people. For example, the metaphor of a system balanced between order and disorder is a commonly used metaphor. It is also a metaphor that can be built with blocks. Participants can then discuss the features of their metaphor and how it relates to company characteristics or other topics of conversation.

Another task in accordance with embodiments of the invention might be for participants to select a famous person from a list, create a model representing that person and then see if any of the group can recognize which person the member had in mind. In trying to convey the message of which person they constructed to their teammates (group members), the individual can use metaphors, move the model about and describe it as it is manipulated, in an attempt to convey meaning to the other group members. After this task is completed, the group can discuss what they do when they have to articulate a complicated concept to others. They can also describe what they do when they feel that they are not getting their point across and how they get other people to see what they see, as they see it. The group can also discuss how they know that they got their point across. It is believed that such a discussion is significantly enhanced when it follows the physical construction and manipulation described above, as opposed to simply discussing concepts in the abstract. Such a generalized discussion can also be used to make group members more comfortable and assured when participating in the more pointed tasks which can follow.

Story telling represents another significant aspect of the invention. It is believed that when facts are embedded in the context of an interesting story, they can have more of a impact on the listening participant and on the participant creating and telling the story, than if facts are recounted in a dry manner. It is also believed that being physically involved with the story provides a more significant impact on a participant than merely hearing (or telling) the story. Thus, by way of example, describing the events of Alexander The Great cutting through the tangle of the Gordian Knot can be more effective than merely repeating the tale's conclusion. However, the lesson was undoubtedly much more vivid for Alexander himself. Thus, Alexander would have been able to draw on his own personal knowledge of having cut through the Gordian Knot as a way of dealing with any subsequent seemingly impossible task that confronts him.

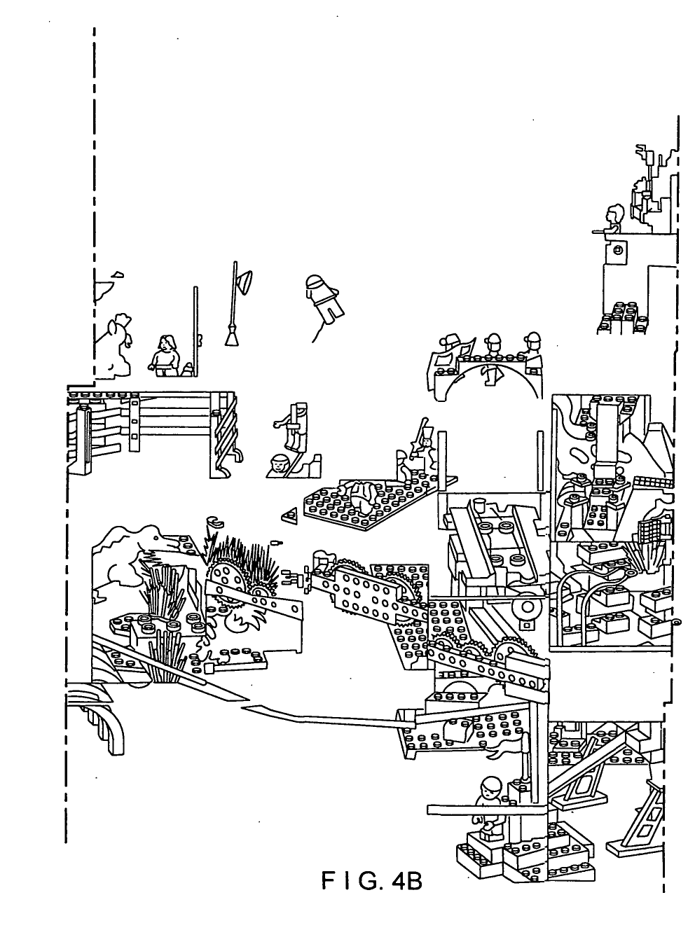

Accordingly, a part of a program conducted in accordance with embodiments of the invention can involve story telling. Participants are given a selection of beginnings of a story (story-openers) to choose from and are given the task of recounting the rest of the story to the group. However, in an effort to enhance the personal involvement of the individual in the story itself, the participants are first given the task of using building blocks (or other objects) to construct an object representing some aspect of the story. By way of non-limiting example, the participant is given the beginning of the story: “This website, www.virtudrive.com, was designed to teach drivers' education over the Internet, the course is free but . . . ” . The participant can also be given the task of creating a model on their own, or building the model from a picture, such as model 300 of FIG. 3. Participants can also be given the choice to select from a plurality of model/story-opener combinations. The story might have to involve all of the aspects of the model they built. Thus, by constructing the model, the individual has developed some physical connection to the story itself, which can enhance the thinking process and make the lessons which flow from the story more meaningful to the teller and listener alike.

After the participants finish recounting their stories and showing their models to the group, they can be asked to tell stories about their company. They can be asked, such as by a trainer, written, audio or video materials, whether they would build a model representing the company as a bird, machine, a celebrity and so forth. They can be asked whether they would talk about the company as having teeth, windows or balance, for example. They can be asked if they would talk it about being stubborn, light on its feet, schizophrenic and so forth. The initial story and model can in large part be in the nature of practice and can act as a “loosening up” exercise for later discussions about the company itself. The physical manipulation of the blocks in making a model will enhance the creativity and openness of the participants and lead to a more effective discussion, than if these topics were simply discussed in the abstract. The participants can also be asked to build models and use those models in telling a story about the company. The model can be a metaphor for some aspect of the company.

The invention can act to improve the constructive imagination of the participants. The term imagination has commonly been given many different meanings and connotations. As used herein, descriptive imagination refers to a type of imagination that is employed to evoke images that describe what can be a complex and confusing world. Industry and competitive analysis is often a structured way to use descriptive imagination to evoke the factors that may determine the attractiveness and profitability of industries.

As used herein, creative imagination refers to the process of evoking truly new possibilities from the combination, recombination or transformation of existing things or concepts. However, when creative imagination enters the realm of fantasy, i.e., the domain of the truly impossible, problems can occur. Thus, whereas fantasy can be considered the domain of the impossible, constructive imagination should be about possible realities and even, the making of reality.

A third type of imagination will be referred to as challenging imagination, which is different from the prior two types. It is with challenging imagination that one negates, defends, contradicts and even destroys the sense of progress that comes from descriptive and creative imagination. The methods of challenging imagination include deconstruction and sarcasm. It is about throwing away and starting over. The inherent risk of the challenging imagination is to have nothing new to put on the slate once it has been wiped clean. The invention helps develop descriptive imagination, creative imagination, and ways of ensuring that something remains on the slate.

Programs conducted in accordance with the invention can help participants to exercise, develop, and enhance their descriptive imagination by making appropriate new combinations or modifications of what already exists. It is useful to first see things exactly as they are and then determine if patterns of success or failure emerge. The judgment accumulated from such an experience can be applied to make better-informed decisions about the future and used to develop simple principals and procedures for addressing new and/or complicated situations.

By way of example, a challenge can be presented to participants in a program run in accordance with embodiments of the invention, in which an imaginary company with existing inventory of old SUV's, represented by SUV designs made from construction blocks, which can be in the form of two or three dimensional models, needs to design what will be next year's new SUV vehicle. The challenge is to examine the old designs and make as many new, different SUV design as possible, by e.g., constructing the old design and thereby learning advantages and attributes of that design and then reconstructing the existing inventory into new designs. As another exemplary exercise, the participants can be presented with existing aircraft inventory, represented by construction block models and given the tasks of reconstructing as many new non-aircraft commuter carriers as they can. Afterwards, the participants can discuss their designs, the problems encountered and how these problems were overcome.

This exercise helps develop imagination and effective communication techniques. By changing what exists, more than what could have been imagined can be realized. When current choices become unacceptable, participants will learn lessons in how to keep what is useful and change the rest. New ideas will be seen to develop from recombining what already exists.

An essential part of the process of the present invention depends on first discovering the identity of a company. Participants of a program conducted in accordance with embodiments of the invention are given the challenge of using the building blocks to build their company identity and to explore and show how all of the many parts fit together in the organization. The process of physically manipulating the blocks has been found to be particularly important in enhancing the thinking process. The participants might be challenged to determine whether the model they have created shows what they are trying to express, whether it shows what is unique about the company and their role in the company, what they value and whether there are details they want to add, change or expand. The participants can then use the model they constructed as a metaphor to tell the story of how they see the company's identity. Their ability to communicate and profit from the experience can be greatly enhanced by the process of constructing the physical metaphors.

Having built individual metaphors of the corporate identity, the participants can then bring together their individual models to form a consensus corporate identity metaphor. This process is particularly effective in enabling individuals to communicate to others their own views as to corporate identity. Through the program, participants will learn to construct a clear and shared identity of their business and their role and their company's role in that business.

Part of understanding a company is to understand the role of various “agents” that occupy the business landscape. As used herein, the term “agent” refers to individuals or other companies that impact, positively or negatively, on a specific business such as the business of the participants in a program conducted in accordance with the present invention. Thus, agents can be customers who buy or do not buy the company's products or creators of new technologies that change the way the company interacts with other agents. An agent can be a discount air-freight company or a consumer protection advocate. These agents can also include employees, suppliers, customers or even databases of information. Participants in the program can build physical metaphors for various agents and explain to each other how those agents affect the company. The explanation can include stories and the stories can involve manipulation (play) with the physical metaphors. The physical metaphors of the various agents constructed can then be placed in relation to each other and the participants of the program can discuss how the various agents affect the company itself. The participants can then determine whether any agents are missing or whether the relation of the agents or relative importance of the various agents should be changed.

The participants will obtain a better understanding of how their business landscape is composed of a network of interdependent agents. The participants can then use special connector set models, such as strings, rigid bars or pivoting bars to connect the various agents, as they deem appropriate. This will help the participants better understand and communicate with each other with respect to various factors that impact their business. The participants can also discuss what can happen to upset the various connections between the interdependent agents. These discussions can involve stories.

The participants can then place markers where, in the physical landscape, they perceive critical issues in the business landscape they constructed. Placing these markers will serve as flags, to encourage discussion about what the participants consider to be things that could have a direct or indirect material effect on the business. Participants can write down changes that could occur in the corporate landscape and later, discuss how these changes affect their model, how to deal with those changes and whether any principles exist which are common to addressing all of the changes.

Programs conducted in accordance with embodiments of the invention can help participants develop simple guiding principles for decision-making in dealing with unforeseen change. As an illustration, the participants can be given the task of building a structure for solving a problem.

They can be given the choice of simple guiding principles, such as:
A. Never stack bricks, always overlap;
B. Lay it out loose before you click;
C. Add-ons fall off—built-ins stay on;
D. It must work before it looks good—and it must look good; and
E. You will always learn something from watching the next person, and instruction such as:
A. A flat base;
B. A foot and column 7 bricks high;
C. A flat floor;
D. Walls of solid bricks two rows high;
E. A leveled brick rim; and
F. Two handles.

Participants are then given the choice of following instructions or guiding principles to solve two types of problems. They will experience that instructions work well when solving foreseeable problems, but that guiding principles are more effective in helping to deal with the unknown. Having experienced for themselves, and having been personally involved in seeing the greater flexibility of guiding principles, participants will learn how powerful they can be in preparing to deal with the unknown.

By way of example, to help develop simple guiding principles for a particular business, such as business corresponding to the landscape made with the models during an earlier part of the program, the participants discuss how the company should respond to one of the potential changes that were identified earlier and decide how the company should respond to that change. The participants can then adapt their landscape to the new situation, then identity the principle that led them to that decision and their subsequent actions. The participants can than go through all of the identified changes and identify all of the principles which govern how they responded to those changes. They can then assess whether the identified guiding principles were simple enough; whether they could be used in every possibility of change in the business landscape; whether everyone agrees with those principles; whether they have been employing those principles all along; how the principles can be disseminated throughout the company; and the circumstances under which those principles should be revised.

Conventional business tools, like mission statements and model forecasts, do not always prove to be successful when the environment on which they are based changes. By engaging in a program conducted in accordance with the invention, participants can gain a sense of awareness of their business, as it exists, how to improve the business, and the fact that it can change, the factors that can effect changes, and how to prepare to deal with changes without the need to predict the future.

Through the creation of models and the discussions involving those models, the participants in exemplary programs will gain an enhanced understanding regarding the connections in the business landscape, whether internal or external, and how a change in those connections can affect the business.

When connections interact, a concept referred to as emergence occurs. This follows the simple law of cause and effect. The more volatile the business landscape, the more powerful the forces of emergence. However, if the connections among agents are understood and simple guiding principles are developed for dealing with changes in those connections, the ability of the company to react and succeed in responding to changes in the business environment can be enhanced.

Employing programs and materials in accordance with preferred embodiments of the invention is a means to that end. Through the use of the bricks and tasks, participants can create a physical representation of their business, its market, consumers and the operational universe. From this three-dimensional landscape, the participants will be able to collectively identify who they will be and how they are positioned. By agreeing to their core identity, they will be able to place the other business players into a landscape and connect them all. Observing the causes and effects that result from the interaction of all of their relevant agents, they will be able to prepare simple guiding principles that will lead them to the right decision, no matter how the connections between the agents and emergence of changes in the business landscape occur.

It will thus be seen that the objects set forth above, among those made apparent from the preceding description, are efficiently attained and, since certain changes may be made in carrying out the above method, program and materials set forth, without departing from the spirit and scope of the invention, it is intended that all matter contained in the above description and shown when the accompanying drawings shall be interpreted, is illustrative and not in an limiting sense.

It is also to be understood that the following claims are intended to cover all of the generic and specific futures of the invention described herein and all statements of the scope of the invention, which, as a matter of language, might be said to fall therebetween.

1. A method for fostering thinking associated with a selected topic, comprising:
assembling a group of participants for the purpose of discussing a selected topic;
causing the participants to construct models with connectable and detachable building blocks to serve as physical metaphors, said metaphors relating to aspects of the topic;
reconfiguring said models as a plurality of new objects:
causing the participants to discuss the models they constructed and describe how the features of the model relate to the topic.

2. The method of claim 1, wherein the topic involves business planning.

3. The method of claim 2, wherein at least one of the metaphors represents an aspect of a company and at least one of the metaphors represents a customer of the company.

4. The method of claim 3, wherein the participants are caused to create physical links between the physical metaphors representing the company and its customers, and the participants discuss the type of link selected and how that relates to how the company and its customers interact.

5. The method of claim 4, wherein the participants discuss how to address changes in the way the company and its customers interact.

6. The method of claim 5, wherein the participants identify guiding principles for governing how to address changes in the way the company interacts with its customers.

7. (canceled)

8. The method of claim 1, wherein at least a portion of the blocks have a rectangular top surface with raised cylindrical pegs and said blocks have a bottom surface configured to releasably receive the pegs, said blocks constructed to connect by inserting the pegs from one block into the bottom of a second block.

9. The method of claim 1, wherein at least a portion of the metaphors constructed represent real people.

10. The method of claim 1, wherein participants construct models selected from a predefined set.

11. The method of claim 1, wherein participants first construct models from a predefined set and then construct their own metaphoric models.

12. (canceled)

13. The method of claim 1, wherein the participants build a model and tell a story relating to the topic that describes aspects of the model.

14. The method of claim 2 wherein at least one of the metaphors represents an aspect of a company and the participants construct models representing guiding principles for governing how to address changes in the way the company implements its business strategy.
